(19) United States
(12) Patent Application Publication
(10) Pub. No.: US 2005/0106422 A1
(43) Pub. Date: May 19, 2005

(54) Thin film with exchange coupling between magnetic grains of the thin film

(75) Inventors: Bin Lu, Pittsburgh, PA (US); Dieter K. Weller, Gibsonia, PA (US); Ganping Ju, Wexford, PA (US); Jai-Young Kim, Sewickley, PA (US)

Correspondence Address: Benjamin T. Queen, II;Pietragallo, Bosick & Gordon, One Oxford Centre, 38th Floor, 301 Grant Street, Pittsburgh, PA, 15219, US

(73) Assignee: Seagate Technology LLC, Scotts Valley, CA (US)

(21) Appl. No.: 10/717,107

(22) Filed: Nov. 19, 2003

(51) Int. Cl. B05D 5/12; B32B 5/16

(52) U.S. Cl. 428/694 TS; 428/328; 428/329; 427/128

(57) ABSTRACT

The invention includes improving or enhancing exchange coupling within a thin film layer. The improvement or enhancement to the exchange coupling occurs between the grains that are deposited to form the thin film. The improvement or enhancement to the exchange coupling between the grains of the thin film results from annealing the thin film at an elevated temperature for a period of time. A thin film structure and/or a magnetic recording layer made in accordance with the invention are disclosed.

### FIELD OF THE INVENTION

The invention relates to a thin film with exchange coupling between magnetic grains of the thin film.

### BACKGROUND INFORMATION

In the field of data storage, areal density is an important factor driving future applications and recording systems. The areal density of current hard disc drive technology, based on predominantly used longitudinal media, is fast approaching its theoretical limit for storage capabilities. One proposed alternative being investigated is perpendicular recording. Perpendicular recording designs are believed to have the potential to support much higher areal densities than conventional longitudinal designs.

Although perpendicular recording has been proposed as a means of achieving increased areal density, it requires a recording medium with high thermal stability, low medium noise and enhanced signal-to-noise ratio (SNR). A specific problem encountered with the perpendicular recording medium design is reducing transition “jitter” noise caused by random positioning of the transition line. In particular, reducing transition “jitter” noise is an important challenge to making the perpendicular recording medium with enhanced SNR and increased density.

The use of thin film structures in constructing various types of recording media is well known. It has been reported that adjusting exchange coupling that takes place between certain thin films of a perpendicular magnetic recording medium may result in the reduction of the transition “jitter” noise. For example, a proposed perpendicular magnetic recording medium design aimed at adjusting the exchange coupling between the thin films that form the medium is coupled-granular-continuous media (CGC) that includes a layer of exchange-coupled grains that are exchange coupled to a layer of exchange-decoupled grains. However, some disadvantages of the CGC media design are that the continuous coupling layer adds to the total thickness of the magnetic layer and increases the head to soft underlayer spacing, and the continuous coupling layer decreases the read and write resolution.

There is identified a need for an improved perpendicular magnetic recording medium that overcomes limitations, disadvantages, or shortcomings of known perpendicular magnetic recording medium.

### SUMMARY OF THE INVENTION

The invention meets the identified need, as well as other needs, as will be more fully understood following a review of this specification and drawings.

An aspect of the invention is to provide a thin film structure comprising a substrate and an annealed thin film layer deposited on the substrate. The annealed thin film layer includes a magnetic material and an oxide material, wherein the annealed thin film layer is annealed to effect exchange coupling between the grains of the magnetic material. The magnetic material may include at least one of Co, Fe, Ni or alloys thereof with Pt, Cr, Pd, or Sm. The oxide material may include SiO₂, HfO₂, Al₂O₃, Sm₂O₃, CoO, CO₂O₃, NiO, Cr₂O₃, CrO₂, TiO₂, ZrO₂ or similar oxides.

Another aspect of the invention is to provide a magnetic recording medium formed on a substrate and comprising an underlayer and a magnetic recording layer deposited on the underlayer. The magnetic recording layer is annealed to effect the exchange coupling between the grains that form the magnetic recording layer.

Another aspect of the present invention is to form a thin film by depositing a thin film layer on a substrate and annealing the thin film layer to effect exchange coupling in the thin film layer. The depositing of the thin film layer may include co-depositing a magnetic layer and an oxide material. The invention may include a thin film magnetic structure made according to the invention. In addition, the invention may include a magnetic recording medium including a thin film magnetic structure made according to the invention.

An aspect of the present invention is to effect exchange coupling in a thin film by heat treating the thin film to effect exchange coupling between grains that form the thin film. The heat treating may be performed for a period of time in the range of about 30 seconds to about 30 minutes. In addition, the heat treating may be performed at a temperature in the range of about 200° C. to about 700° C. Heat treating may be, for example, a vacuum anneal process or a rapid thermal anneal process.

These and other aspects of the present invention will be more apparent from the following description.

### BRIEF DESCRIPTION OF THE DRAWINGS

FIG. 1 is a pictorial representation of a disc drive that may utilize a perpendicular recording medium in accordance with the invention.

FIG. 2 is a partially schematic side view of a perpendicular magnetic recording head and a perpendicular recording magnetic medium in accordance with the invention.

FIG. 3 is a partially schematic side view of a perpendicular magnetic recording medium constructed in accordance with the invention.

FIG. 4 is an image of CoPt alloy grains embedded in an Al₂O₃ matrix for constructing a thin film or magnetic recording layer in accordance with the invention.

FIG. 5 illustrates a set of MOKE hysteresis loops for a CoPt alloy embedded in an Al₂O₃ matrix.

FIG. 6 is a graphical illustration of hysteresis loop slope, α, versus annealing temperature.

FIG. 7 is a set of MOKE hysteresis loops for a CoPt alloy embedded in an O₂ matrix.

FIG. 8 illustrates a set of MOKE hysteresis loops for a CoPt alloy embedded in an SiO₂ matrix.

### DETAILED DESCRIPTION

The invention provides a thin film magnetic structure. The invention is particularly suitable for use with a perpendicular magnetic recording medium of a magnetic disc storage system. However, it will be appreciated that the invention has utility for other applications requiring thin films where the exchange coupling between the grains of the thin film can be adjusted or controlled.

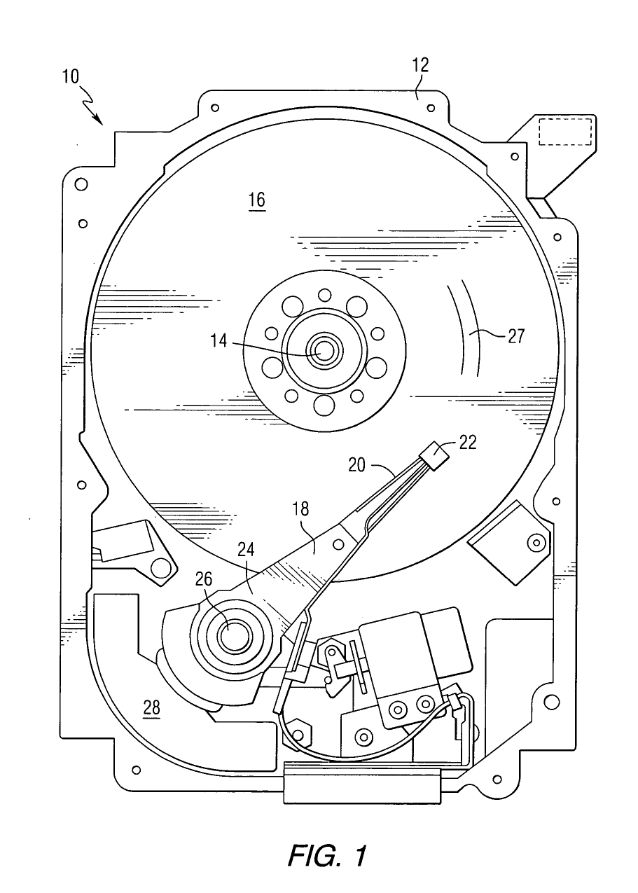

FIG. 1 is a pictorial representation of a disc drive 10 that can utilize a perpendicular recording medium in accordance with this invention. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium 16, which may be a perpendicular magnetic recording medium, within the housing 12. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well known in the art.

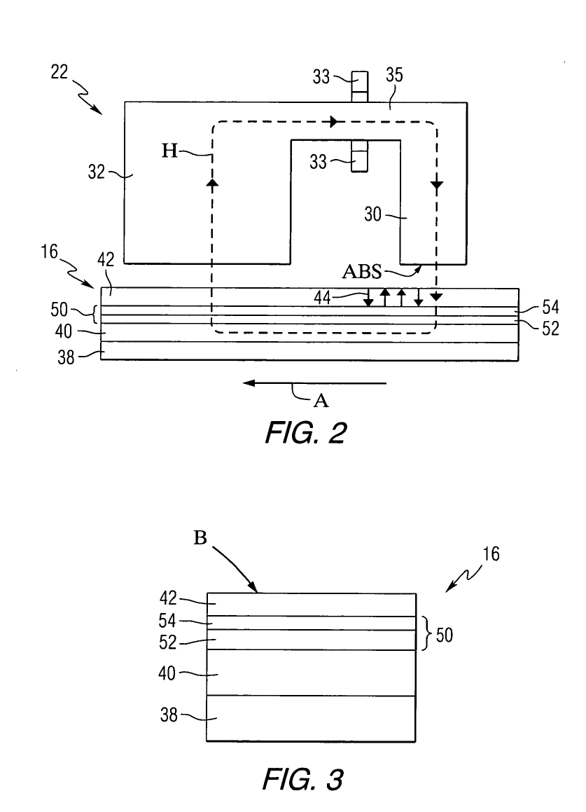

FIG. 2 is a partially schematic side view of a perpendicular magnetic recording head 22 and a perpendicular recording magnetic medium 16 positioned adjacent to or under the recording head 22. The recording medium 16 travels in the direction of arrow A during recording. The recording head 22 is well known in the art and includes a writer section comprising a trailing main pole 30 and a return or opposing pole 32. A magnetizing coil 33 surrounds a yoke 35, which connects the main pole 30 and return pole 32. The recording head 22 also may include a reader section (not shown), as is generally known in the art. The reader may include, for example, a conventional GMR reader, MR reader, inductive reader, or the like (not shown) as is also generally known in the art.

Referring to FIGS. 2 and 3, the recording medium 16 may include a substrate 38, which may be made of any suitable material such as ceramic glass, amorphous glass, or NiP plated AlMg. A soft magnetic layer 40 may be deposited on the substrate 38. The soft magnetic layer 40 may be made of any suitable material such as FeCoB, CoZrNb or NiFeNb. The soft magnetic layer 40 may have a thickness in the range of about 50 nm to about 500 nm. The medium 16 may also include an intermediate layer 50 formed adjacent to or on the soft magnetic layer 40. More specifically, the intermediate layer 50 may include a seedlayer 52 and an underlayer 54. The seedlayer 52 may comprise, for example, CoCrRu, CoCr, W, Ta, Mo, Hf, or Ti. The seedlayer 52 may have a thickness in the range of about 1 nm to about 10 nm. The underlayer 54 may be formed of, for example, Ru or CrRu. The underlayer 54 may have a thickness in the range of about 1 nm to about 10 nm.

The recording medium 16 may also include a magnetic recording layer 42, which in this embodiment is a perpendicular recording layer as illustrated by the perpendicular oriented magnetic domains 44. The magnetic recording layer 42 may be deposited adjacent to or on the intermediate layer 50 that is formed adjacent to or on the soft magnetic layer 40. Although not shown, a protective overcoat, such as a diamond-like carbon, and/or a lubricant layer may be applied over the hard magnetic recording layer 42 as is generally known.

In accordance with the invention, a thin film structure having improved or enhanced exchange coupling within the thin film layer is provided. More specifically, the improved or enhanced exchange coupling occurs between the grains, i.e., inter-granular, that are deposited to form the thin film. The improvement or enhancement to the exchange coupling between the grains of the thin film results from annealing the thin film at an elevated temperature for a period of time. While the invention has application for thin films in general, an embodiment of the invention will be described herein with reference to, for example, the aforementioned recording layer 42 for the perpendicular magnetic recording medium 16.

As described, the magnetic recording layer 42 is deposited on the intermediate layer 50 as illustrated in FIGS. 2 and 3. The recording layer 42 is deposited, for example, by co-sputtering a magnetic material, such as Co, Fe, Ni or alloys thereof with Pt, Cr, Pd, or Sm, with an oxide material, such as SiO₂, HfO₂, Al₂O₃, Sm₂O₃, CoO, CO₂O₃, NiO, Cr₂O₃, CrO₂, TiO₂, or ZrO₂. The magnetic material may have grains in the range of about 3 nm to about 50 nm. The oxide material selected is preferably an oxide with high diatomic bond strength. Conventional sputtering techniques and parameters may be employed for carrying out the co-sputtering of the selected materials for forming the recording layer 42.

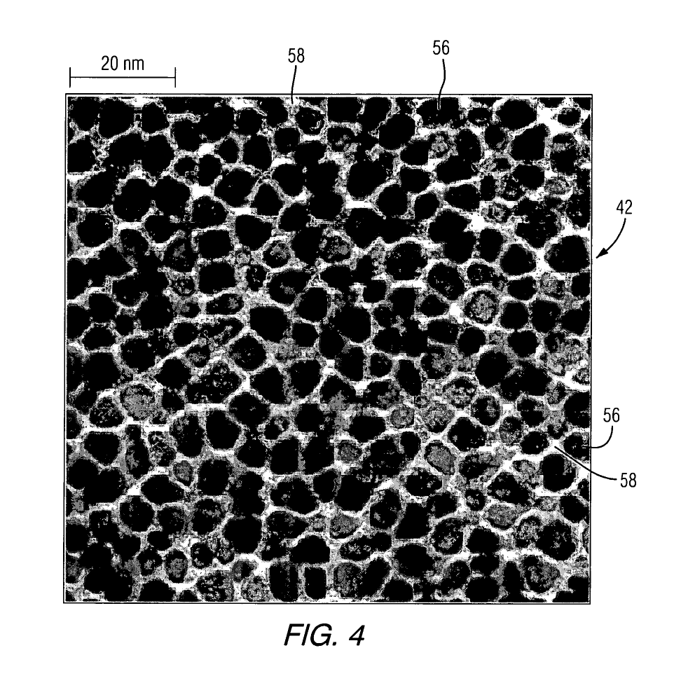

FIG. 4 is an image of CoPt alloy grains 56 embedded in an Al₂O₃ matrix 58 for constructing, for example, the magnetic recording layer 42 in accordance with the invention. For example, the sputter power of Co used may be between 100 W and about 400 W and the sputter power of Pt may be between about 0 W and about 100 W. The ratio of the Co/Pt power controls the composition of the CoPt-alloy. The sputter power of the oxide may be between about 10 W and about 50W. The power at which the oxide is sputtered controls the amount of the oxide used for decoupling the magnetic CoPt alloy grains. The Ar pressure during the deposition may be between about 10 mTorr and about 60 mTorr. Oxygen may be used during the sputtering in the amount of about 0.2%-2% of the total Ar⁺ O₂ flow.

Once deposited, the recording layer 42 is annealed, as indicated by arrow B in FIG. 3, to enhance or improve the exchange coupling between the grains 58 of the recording layer 42. In accordance with the invention, the annealing may be, for example, a vacuum anneal process or a rapid thermal anneal process. In addition, the annealing may be performed at a temperature, for example, in the range of about 200° C. to about 700° C. In another embodiment, the annealing may be performed at a temperature in the range of about 300° C. to about 500° C. The annealing may be performed for a period of time, for example, in the range of about 30 seconds to about 30 minutes. In another embodiment, the annealing may be for a period of time in the range of about 1 minute to about 10 minutes.

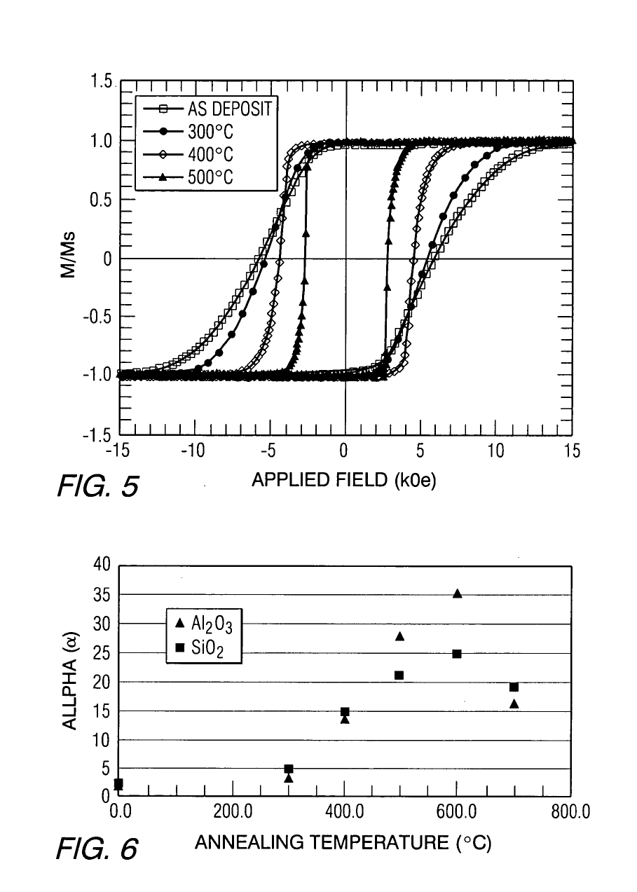

FIG. 5 illustrates a set of MOKE hysteresis loops for the CoPt alloy and Al₂O₃ recording medium 42 illustrated in FIG. 4. The various loops, as indicated, are for the as deposited thin film and the thin film as annealed at 300° C., 400° C. and 500° C. all for a period of about 10 minutes. The as deposited sample, as illustrated in FIG. 4, contains well defined and well decoupled magnetic grains 56 of the CoPt alloy with the Al₂O₃ oxide material 58 preventing the grains 58 from touching each other. This is indicated by, for example, the hysteresis loop of the as-deposited recording medium or thin film being sheared which suggests a well decoupled microstructure. FIG. 5 clearly illustrates that as the recording medium 42 is annealed to higher temperatures, the slope of the hysteresis loop gets steeper. In addition, the squareness (S) is kept constant and the coercivity (Hc) is decreasing as the annealing temperature is increasing. This indicates that the magnetic grains are becoming more exchange coupled as the annealing process is applied thereto.

The slope of the hysteresis loop is defined as:

$$α = 4 π \frac{ⅆ M}{ⅆ H} \vert ( H = Hc ) .$$

If the magnetic grains are well decoupled, the value of α approaches 1. If the magnetic grains are strongly exchange coupled, α should be approaching larger values above 10. FIG. 6 shows that α increases with the annealing temperature. The data points at 0° C. represent the as deposited CoPt samples with Al₂O₃ and SiO₂ as the grain separator. The α values are approximately 1.38 and 1.58, respectively. These low α values indicate that the as deposited films have well decoupled CoPt magnetic grains. When the samples are annealed at higher temperatures, the α values increase monotonically. From FIG. 6, it can be concluded that within the annealing temperature range of as-deposited and about 700° C., the α value can be adjusted continuously. This provides a practical method to modify and fine-tune the inter-granular exchange coupling. Accordingly, the degree of exchange coupling between the ferromagnetic grains, in this case CoPt alloy grains, can be controlled by adjusting the annealing temperature and/or the annealing duration continuously.

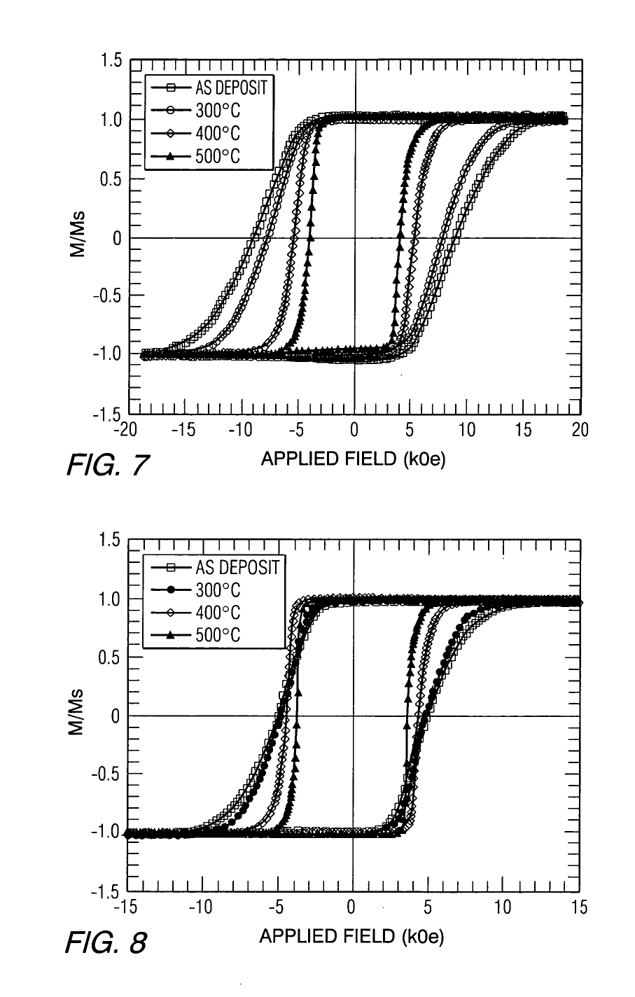

FIG. 7 illustrates a set of MOKE hysteresis loops for an additional recording medium or thin film constructed in accordance with the invention. Specifically, the results set forth in FIG. 6 are for a CoPt alloy magnetic material deposited with a flow of O₂. The loops set forth in FIG. 6 are for the as deposited thin film and the thin film as annealed at temperatures of 300° C., 400° C. and 500° C. for an annealing duration of about 10 minutes. Similar to the results set forth in FIG. 5, it can clearly be seen that as the thin film is annealed to a higher temperature, the slope of the loop is getting steeper. This indicates that the magnetic grains are becoming more exchange coupled.

FIG. 8 illustrates an additional set of MOKE hysteresis loops for a recording medium or thin film constructed in accordance with the invention. This particular thin film was formed by depositing a CoPt alloy with SiO₂ and then annealing at 300° C., 400° C. and 500° C. for a period of about 10 minutes. Again, the results set forth in FIG. 8, similar to the results shown in FIGS. 5 and 7, indicate that the exchange coupling is being improved or enhanced between the magnetic grains of the thin film as the annealing process is performed thereon.

Accordingly, the present invention provides for effecting exchange coupling in thin films obtained by co-sputtering magnetic materials and oxide materials. The as deposited thin films include well decoupled magnetic grains separated by the oxide at the grain boundary. The vacuum or rapid thermal annealing provides for adjusting the inter-granular exchange coupling in a wide range and continuous manner. In the application of magnetic recording media, the final exchange state between the magnetic grains in the media can be adjusted to an acceptable value which provides minimized or reduced transition noise.

Whereas particular embodiments of this invention have been described above for purposes of illustration, it will be evident to those skilled in the art that numerous variations of the details of the present invention may be made without departing from the invention as defined in the appended claims.

1. A thin film structure, comprising:
a substrate; and
an annealed thin film layer on said substrate, said annealed thin film layer including a magnetic material and an oxide material, wherein the annealing of said annealed thin film layer effects the exchange coupling between the grains of said magnetic material.

2. The thin film structure of claim 1, wherein said annealed thin film layer is annealed for a period of time in the range of about 30 seconds to about 30 minutes.

3. The thin film structure of claim 1, wherein said annealed thin film layer is annealed at a temperature in the range of about 200° C. to about 700° C.

4. The thin film structure of claim 1, wherein said magnetic material includes at least one of Fe, Co, Ni, or alloys thereof with Pt, Cr, Pd or Sm.

5. The thin film structure of claim 1, wherein the grains of said magnetic material have a size in the range of about 3 nm to about 50 nm.

6. The thin film structure of claim 1, wherein said oxide material includes at least one of Al₂O₃, NiO, Sm2O3, ZrO2, TiO2, SiO₂, HfO₂, CoO, CO₂O₃ or CrO₂.

7. The thin film structure of claim 1, wherein said annealed thin film layer is structured and arranged for data storage.

8. A magnetic recording medium formed on a substrate, comprising:
an underlayer on the substrate; and
a magnetic recording layer on said underlayer, wherein said magnetic recording layer is annealed to effect the exchange coupling between grains of said magnetic recording layer.

9. A method for effecting exchange coupling in a thin film, comprising:
heat treating the thin film to effect exchange coupling between grains that form the thin film.

10. The method of claim 9, wherein the heat treating is performed for a period of time in the range of about 30 seconds to about 30 minutes.

11. The method of claim 9, wherein the heat treating is performed at a temperature in the range of about 200° C. to about 700° C.

12. The method of claim 9, wherein the heat treating is a vacuum anneal process or a rapid thermal anneal process.

13. A method for forming a thin film, comprising:
depositing a thin film layer on a substrate; and
annealing the thin film layer to effect exchange coupling in the thin film layer.

14. The method of claim 13, wherein the depositing of the thin film layer includes co-depositing a magnetic material and an oxide material.

15. The method of claim 14, wherein the effected exchange coupling occurs between grains of the magnetic material.

16. The method of claim 15, wherein the effect on exchange coupling is an increase in the exchange coupling between grains of the magnetic material.

17. The method of claim 13, wherein the annealing is performed for a period of time in the range of about 30 seconds to about 30 minutes.

18. The method of claim 13, wherein the annealing is performed at a temperature in the range of about 200° C. to about 700° C.

19. A thin film magnetic structure made according to the method of claim 13.

20. A magnetic recording medium including a thin film magnetic structure made according to the method of claim 13.
